(19) United States
(12) Patent Application Publication
(10) Pub. No.: US 2007/0066427 A1
(43) Pub. Date: Mar. 22, 2007

(54) Friction damped blade tensioner

(75) Inventor: Roger T. Simpson, Ithaca, NY (US)

Correspondence Address: BORGWARNER INC., 3850 HAMLIN ROAD, AUBURN HILLS, MI, 48326, US

(73) Assignee: BorgWarner Inc., Auburn Hills, MI (US)

(21) Appl. No.: 11/229,927

(22) Filed: Sep. 19, 2005

(51) Int. Cl. F16H 7/08; F16H 7/18

(52) U.S. Cl. 474/111; 474/140

(57) ABSTRACT

The chain tensioner includes a tensioner arm with a blade spring and a wedge-shaped piston. Complementary friction surfaces of a pair of pawls push against the wedge-shaped piston to dampen the motion of the blade tensioner and hence tension the chain. The pawls are urged together and against the piston by spring loading. The combination of a blade tensioner and a wedging feature provides better chain control than a blade tensioner alone. The system requires no hydraulic fluid pressure from the engine.

### BACKGROUND OF THE INVENTION

1. Field of the Invention

The invention pertains to the field of chain tensioner. More particularly, the invention pertains to a blade tensioner damped by wedging friction.

2. Description of Related Art

Chain vibrations during the operation of a chain and sprocket system produce noise and cause the chain to wear. Providing tension to the chain with a chain tensioner or a chain guide reduces the chain vibrations. As the chain wears, it lengthens, requiring the tensioner to adjust in order to maintain tension and control of the chain.

U.S. Pat. No. 5,951,423, “MECHANICAL FRICTION TENSIONER”, issued Sep. 14, 1999, discloses a mechanical chain tensioner having a wedge-shaped plunger that pushes against two spring-loaded wedge-shaped blocks to keep a minimal force on a chain as it slackens. The tensioner provides the advantages of a conventional hydraulic tensioner, but eliminates the hydraulic pressure system by use of spring-loaded wedge-shaped blocks and friction damping.

U.S. Pat. No. 6,146,300, “TENSIONER DEVICE FOR CHAIN DRIVE MECHANISM”, issued Nov. 14, 2000, discloses a tensioner having a ratchet part and an oil-filled part. The ratchet has a plunger with a row of ratchet teeth received by a housing integral to a tensioner arm. A spring urges the plunger out from the housing. A pawl pivotally connected to the housing and meshing with the ratchet teeth prevents movement towards the housing. The oil filled part includes a housing with a bore for slidably receiving a piston and a compression spring acting between the housing and the piston, urging the piston away from the housing. The stop mechanism may include a conical surface formed at an open end of the first housing, and a plurality of spring-biased balls urged to wedge into an annular space defined between the conical surface and an outer peripheral surface of the plunger.

U.S. Pat. No. 6,155,941, “HYDRAULIC TENSIONER HAVING A FLEXIBLE BLADE ARM”, issued Dec. 5, 2000, discloses a chain tensioner with a hydraulic tensioner and a tensioner arm with a spring blade. The hydraulic tensioner applies force against the end of the tensioner arm. The arm is pivotally supported at one end and supported by the tensioner piston at the other end. A blade spring is inserted into the plastic shoe to provide tension to the arm.

There is a need in the art for a chain tensioner with improved vibrational damping throughout chain life to dampen chain vibrations in a chain and sprocket system.

### SUMMARY OF THE INVENTION

The chain tensioner includes a tensioner arm with a blade spring and a wedge-shaped piston. Complementary friction surfaces of a pair of pawls push against the wedge-shaped piston to dampen the motion of the blade tensioner and hence tension the chain. The pawls are urged together and against the piston by spring loading. The combination of a blade tensioner and a wedging feature provides better chain control than a blade tensioner alone. The system requires no hydraulic fluid pressure from the engine.

The blade tensioner system for a chain includes a blade shoe with an arcuately curved chain sliding face, a proximal end portion pivotally attached to a bracket, and a distal end portion. The system further includes a blade spring in contact with the blade shoe for supporting the chain sliding face. The system also includes a piston with tapering sides. The piston extends from a side of the blade shoe opposite the chain sliding face. Additionally, the system includes a pair of pawls. Each pawl has a complementary surface for slidably supporting a tapered side of the piston. The complementary surfaces of the pawls face each other so that the tapering sides of the piston are received between the pair of pawls. The system further includes a biasing device for urging the pair of pawls toward each other. A frictional force between the tapered sides of the piston and the complementary surfaces of the pair of pawls resists both deflection and restoration of the blade spring.

In an embodiment of the present invention, a shoe sliding surface slidably receives the distal end portion of the blade shoe. The biasing device preferably includes a pair of springs, and the pair of springs are preferably helical springs. In another embodiment, the biasing device is a torsion spring contacting the pair of pawls. Each pawl is preferably mounted on a dowel, with each dowel being slidingly mounted to a mounting block mounted to the bracket. The bracket is preferably a stamped steel bracket.

The method of controlling a chain by simultaneous damping of chain vibrations and tensioning of the chain includes rotatably mounting a blade shoe supported by a blade spring and having an arcuately curved chain sliding face to slidingly contact and tension the chain. The method further includes the wedging of tapered sides of a piston supporting the blade spring between complementary surfaces of a pair of pawls urged toward each other by a biasing device to provide a frictional resistance to both deflection and restoration of the blade spring under force from the chain.

### BRIEF DESCRIPTION OF THE DRAWINGS

FIG. 1 shows a first embodiment of the present invention with helical springs.

FIG. 2 shows a second embodiment of the present invention with a Neg'ator spring.

FIG. 3A shows the embodiment of FIG. 1 under a minimal load.

FIG. 3B shows the embodiment of FIG. 1 under a new chain load.

FIG. 3C shows the embodiment of FIG. 1 under a worn chain load.

FIG. 4 shows schematic force-displacement curves for several tensioning devices.

### DETAILED DESCRIPTION OF THE INVENTION

The present invention uses the idea of friction pawls pushing against a wedge-shaped piston to dampen the motion of a blade style tensioner. The force pushing on the piston and thus pushing the pawls apart may be made many times higher than the force required to return the piston to a retracted state relative to the pawls. The added force is coulomb friction, and it reduces the motion of the chain as it tries to vibrate. As the chain wears, the blade shoe of the tensioner has to bow further outward to tension the chain, compensating for elongation of the chain. With the piston being attached to the blade shoe, the position of contact between the pawls and the piston changes as the chain wears. Since the pawls are spring-biased, the pawls remain in contact with the piston even when the chain is worn. Therefore, the tensioning system is self-adjusting throughout the life of the chain. Also, this system is fully functional during engine cranking and before the engine oil pressure is available, as it requires no oil pressure from the engine to function. The combination of the tensioner blade and the wedge makes the mechanical tensioner perform like a hydraulic tensioner.

The parts are simple powdered metal parts and may be hardened for good durability. The piston and the pawls are preferably made of hardened steel with a high coefficient of friction or of a steel-plastic composite formed by metal injection molding (MIM). A steel-plastic composite is preferably approximately 80% steel and 20% plastic.

In one embodiment of the present invention, the piston is riveted to a blade spring and the blade spring provides the return spring force. The blade spring also holds the piston in place and supports the plastic face the chain rides on. The tensioning system may also have two springs perpendicular to the piston, and the design may be made compact for applications with limited space requirements. The amount of friction damping is adjusted by adjustment of the spring force and the angles of the pawls and piston. Increasing the angle of the piston wedge decreases the frictional force resisting withdrawal of the piston from the pawls.

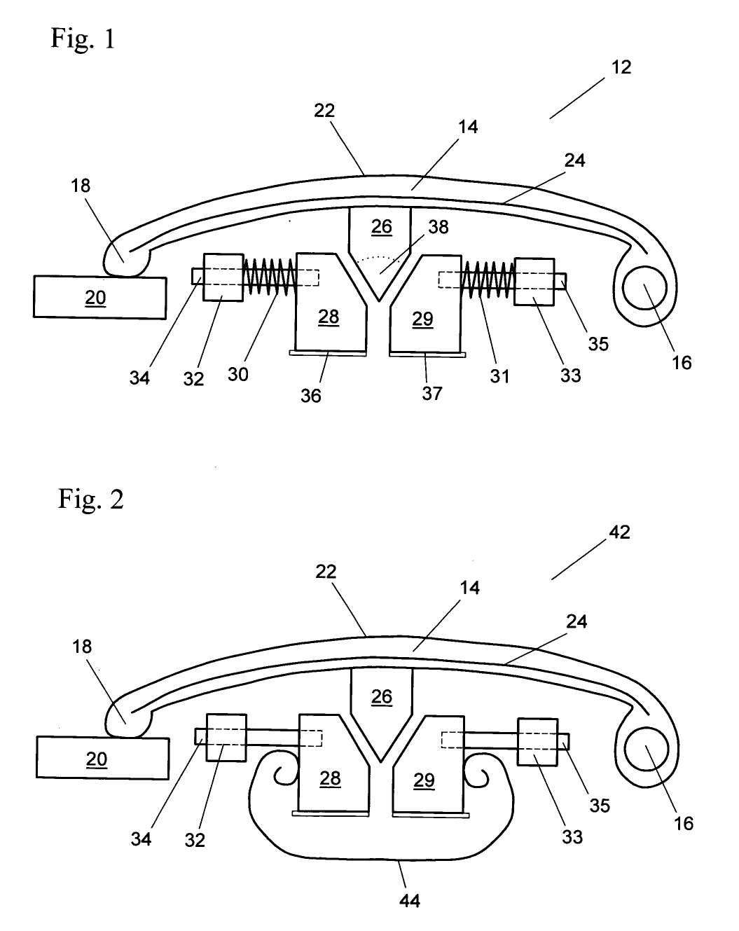

In an embodiment of the present invention as shown in FIG. 1, the chain tensioner 12 includes an arcuately curved tensioner arm 14 with a distal end 18, a proximal end, and a chain sliding face 22. The proximal end of the arm is pivotally mounted to the engine housing or a bracket by a pivot pin 16. The distal end 18 of the blade shoe slides on a sliding block 20. The arm 14 contains a blade spring 24 for supporting the chain sliding face 22.

Extending from the concave side opposite the chain sliding face 22 of the tensioner arm 14 is a wedge block 26, hereafter described as a piston, having a pair of lateral sides which are straight and then taper away from the blade shoe. The sides of the piston 26 taper to form a wedge angle 38, which may be varied to adjust the friction damping force. The piston 26 is received between two wedge-receiving blocks 28, 29, hereafter described as pawls, which have angled surfaces complementary to the tapering wedge surfaces of the piston. The pawls 28, 29 are urged toward the wedge block by two helical springs 30, 31 extending from mount blocks 32, 33. The mount blocks are preferably mounted to the engine housing or the stamped steel bracket, and the springs 30, 31 are preferable supported by dowels 34, 35 mounted to the pawls 28, 29 and extending through the centers of the springs and the mount blocks. The pawls 28, 29 are also preferably supported on their distal surfaces 36, 37 by a support surface to prevent rotation of pawls under force from the chain.

Alternatively, the sides of the piston 26 may be slightly curved and in turn the tapered wedge surfaces of the pawls 28, 29 would also have curved angled surfaces complementary to the curved tapering wedge surfaces or sides of the piston 26. By having a piston with curved sides and pawls with curved sides, the point of contact between the pawls and the piston would be different than the point of contact between the piston and the pawls with straight sides, and therefore the force friction curve would also be different.

A stamped steel bracket preferably holds the pivot pin for the blade shoe, provides a support surface for the distal end of the blade shoe to push against, and also holds a mount for the pawls. In a preferred embodiment, a single piece of stamped steel is used to form the bracket for mounting the tensioner, the sliding block for receiving the distal end of the tensioner arm, the mounting blocks for receiving the dowels, and the support surface for supporting the pawls. The support surface and the sliding block are preferably formed as horizontal shelves by cutting a piece of the stamped steel on three sides and bending it upward. The mounting blocks are preferably each formed as a vertical piece by cutting a piece of the stamped steel on three sides and bending it upward to face the pawls.

In another embodiment of the present invention as shown in FIG. 2, the chain tensioner 42 includes a torsion spring 44, which contacts the outside surfaces of the two pawls and urges the pawls 28, 29 toward the piston 26. In this embodiment, the single torsion spring 44 replaces the pair of helical springs 30, 31 of the chain tensioner 12 of FIG. 1.

Applications for the present invention include but are not limited to oil pump drives, short center distance drives, cam-in-block drives, and balance shaft drives. The present invention could also be applied as a chain snubber for a transfer case and transmission drives where damping is required and there is no tensioner or oil supply for pressure. The present invention does not require any oil pressure from the engine, only small amounts of oil to lubricate the pawl surfaces.

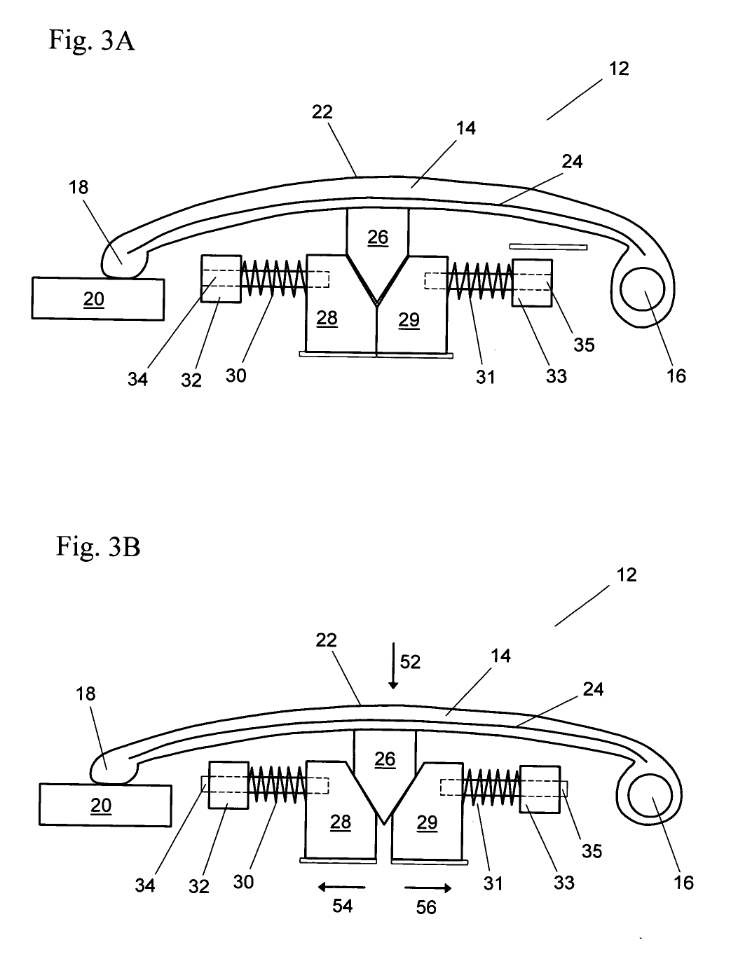

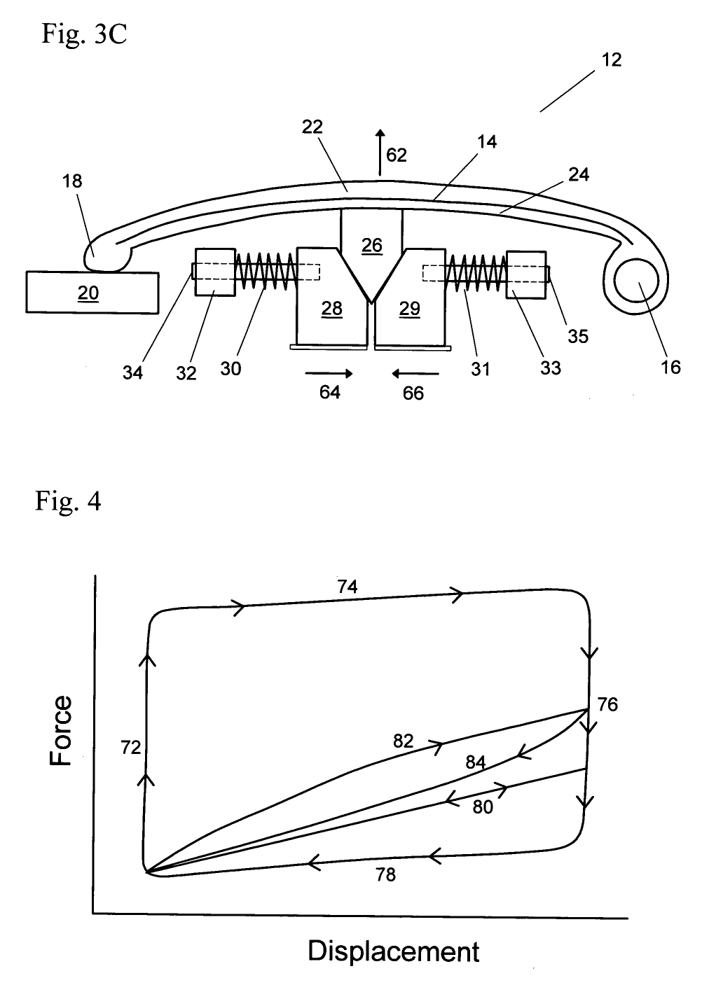

In FIG. 3A, the assembled chain tensioner 12 is shown prior to chain loading. The helical springs 30, 31 are extended and the pawls 28, 29 are in contact with each other. After loading, as shown in FIG. 3B, the downward force 52 applied by the chain causes the tensioner arm 14 to flatten and lengthen, pushing downward on the blade spring 24 and the piston 26. As the piston 26 pushes into the pawls 28, 29, the pawls separate 54, 56 slightly. The helical springs 30, 31 resist the separation of the pawls 28, 29. As the chain lengthens due to wear, as shown in FIG. 3C, the blade shoe 22 of the tensioner has to bow further outward 62 to tension the chain, compensating for elongation of the chain. With the piston 26 being attached to the blade shoe 22, the position of contact between the pawls 28, 29 and the piston 26 changes as the chain wears. This bowing is resisted and damped by friction between surfaces of the piston 26 contacting the pawls 28, 29. Since the pawls are spring-biased, as the piston moves upward, the helical springs 30, 31 push the pawls 28, 29 inward 64, 66 to maintain them in frictional contact with the piston 26 even when the chain is worn.

Referring to FIG. 4, schematic force-displacement curves are shown for various types of tensioners. For a prior art hydraulic tensioner or friction tensioner, a large force is necessary to press the piston in toward the housing 72, increasing displacement until a threshold is reached 74. The displacement of the piston of the prior art tensioners return to the initial or starting displacement point through curves 76 and 78. These properties do allow these types of tensioners to provide damping of chain vibrations through the force required to press the piston toward the housing

Curve 80 shows the displacement of a blade spring only and any force put in comes out, resulting in no damping. Curves 82 and 84 show the displacement of a plastic blade shoe used with the present invention. The plastic blade shoe deflects and restores more gradually than the prior art hydraulic and friction tensioners and does provide some damping. The difference between curves 82 and 84 results from the bending of the plastic for a blade tensioner.

The blade tensioner with the wedging feature of the present invention follows curves 72, 74, 76, and 78. The force required to press the blade shoe 22 is increased to curve 74 by the wedging of piston 26 into spring loaded pawls 28, 29. The blade spring 14 then pulls the blade shoe back to its original state during curves 76 and 78.

One of the advantages of the tensioner of the present invention is that no hydraulics are needed. Therefore, during a first engine start when hydraulic pressure is not present, the chain is still tensioned by the tensioner of the present invention.

Although the pawl motion is shown in the figures to be in the lengthwise direction of the tensioner arm, the piston and pawls may be rotated in any direction about an axis running down the length of the piston, as space permits, within the spirit of the present invention.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A blade tensioner system for a chain comprising:
a blade shoe having an arcuately curved chain sliding face, a proximal end portion pivotally attached to a bracket, and a distal end portion;
a blade spring in contact with the blade shoe for supporting the chain sliding face;
a piston having tapering sides and extending from a side of the blade shoe opposite the chain sliding face;
a pair of pawls, each pawl having a complementary surface for slidably supporting a tapered side of the piston, the complementary surfaces of the pawls facing each other so that the tapering sides of the piston are received between the pair of pawls; and
a biasing device for urging the pair of pawls toward each other;
such that a frictional force between the tapered sides of the piston and the complementary surfaces of the pair of pawls resists both a deflection and a restoration of the blade spring.

2. The blade tensioner system of claim 1 further comprising a shoe sliding surface for slidably receiving the distal end portion of the blade shoe.

3. The blade tensioner system of claim 1, wherein the biasing device comprises a pair of springs.

4. The blade tensioner system of claim 3, wherein the pair of springs are helical springs.

5. The blade tensioner system of claim 1, wherein the biasing device comprises a torsion spring contacting the pair of pawls.

6. The blade tensioner system of claim 1, wherein each pawl is mounted on a dowel, each dowel being slidingly mounted to a mounting block mounted to the bracket.

7. The blade tensioner system of claim 1, wherein the bracket is a stamped steel bracket.

8. The blade tensioner system of claim 1, wherein the piston is riveted to the blade spring.

9. The blade tensioner system of claim 1, wherein the tapered sides of the piston and the complementary surfaces of the pawls for slidably supporting the tapered sides of the piston are curved.

10. A method of controlling a chain by simultaneous damping of chain vibrations and tensioning of the chain comprising the steps of:
a) rotatably mounting a blade shoe supported by a blade spring and having an arcuately curved chain sliding face to slidingly contact and tension the chain; and
b) wedging tapered sides of a piston supporting the blade spring between complementary surfaces of a pair of pawls urged toward each other by a biasing device to provide a frictional resistance to both deflection and restoration of the blade spring under a force from the chain.
